(19) United States
(12) Patent Application Publication
(10) Pub. No.: US 2003/0093786 A1
(43) Pub. Date: May 15, 2003

(54) Interactive television method and device

(76) Inventor: Eric Amsellem, Paris (FR)

Correspondence Address: YOUNG & THOMPSON, 745 SOUTH 23RD STREET 2ND FLOOR, ARLINGTON, VA, 22202

(21) Appl. No.: 10/220,617

(22) PCT Filed: Sep. 21, 2001
(86) PCT No.: PCT/FR01/02951

(30) Foreign Application Priority Data
Sep. 22, 2000 (FR) 00/12125

(51) Int. Cl. H04N 7/173; H04N 7/16; H04N 7/00; H04N 11/00

(52) U.S. Cl. 725/24; 725/135; 725/139; 725/105; 725/109; 348/461

(57) ABSTRACT

The invention concerns a method for producing an interactive television broadcast. The viewer is provided with a decoder wherein is stored a programme or interactive application for masking certain video sequences (43, 44, 45) received via satellite, with OSD masking images (46) generated by the decoder. The selection of video sequences to be masked is carried out on the basis of signals derived from a remote control unit in response to a prior selection (42) of the user.

The present invention relates to a method enabling a television broadcast to be made interactive. It also concerns a device implementing this method. The invention can be applied particularly advantageously, but not exclusively, to the transmission of interactive televised games for digital television. It also relates to a system for the implementation of this method.

To benefit from digital television, it is possible to have a satellite dish installed to receive broadcasts via a satellite, and a decoder connected to a television set. Instead of transmission via satellite, there is also cable or even terrestrial digital transmission. To establish customer loyalty, a digital television channel may offer its viewers the chance to participate in interactive games. Most decoders include a modem for the return route to a broadcasting central site. However, existing technologies do not allow effective management in real time of the responses of each of the viewers.

For a television game to be interactive, it must be possible for the video stream displayed by the viewer to be customised. For this purpose it is necessary either for the broadcasting central site to broadcast a customised video stream to each of the viewers, which does not seem possible at present, or for the broadcasting central site to broadcast several distinct video streams simultaneously, and each decoder only displays the video stream adapted to the corresponding viewer. For the second case existing decoders have a very small memory capacity, of the order of four hundred kilobytes, which does not allow them to generate, in the same channel, video streams with a video pass band of the order of five megabytes.

The present invention aims to overcome these drawbacks by proposing an interactive television method, between a broadcasting central site and a plurality of local sites equipped with television receivers provided with decoders to receive digitally encoded video streams.

According to the invention this method includes transmission, from the broadcasting central site, of a video stream corresponding, in certain predetermined time slots, to a spatial group of several simultaneous video sequences, the displayed image resulting from this group comprising at least as many zones as video sequences. Moreover, at each local receiving site, masking steps are carried out, masking one or more of the zones of the displayed image by means of masking images, these masking steps being synchronised with predetermined time slots and being carried out within the decoder in response to validation instructions transmitted by means of remote control.

In other words, a video image is transmitted, which is in fact made up of encrusted several video sub-images, or video sequences. On the screen, several zones are seen, each displaying one of the video sequences. The validation instruction can be a signal transmitted from a decoder remote control by means of this remote control's keys or directional arrows.

With such a method, the central site can broadcast a pre-formatted video stream made up of several different video sequences, and the decoder does not carry out a selection of video sequences, but carries out a masking procedure. Each viewer sees, displayed on his television screen, a video sequence corresponding to his choice expressed by means of the remote control. The viewer has the impression of being directly interactive with the broadcasting central site, whereas in reality, everything is being carried out locally in his decoder.

The masking images may include fixed low-capacity images. Images are preferably used, produced by “OSD” (on-screen display) technology, generally used for displaying the control parameters (volume, contrast etc.) of a television set for example. Masking technique on MPEG2-type signals can be quoted according to document WO 9 533 342. This technique makes it possible to replace pixels of a first video source by pixels of one second video source, this replacement being facilitated by the specific addressing of signals MPEG2.

To manage these masking images, an autonomous interactive application is used, which is included within the decoder's storage means.

According to an advantageous characteristic of the invention, the masking images, as well as the interactive application are downloaded into the decoder's storage means from the start of broadcasting of the video stream. Moreover, the predetermined time slots can be predefined in the interactive application, i.e. the interactive application is a piece of software which integrates these time slots. Otherwise, it can be imagined that these time slots are defined by synchronization signals transmitted instantaneously by the central site. These synchronisation signals allow a masking image to be displayed during a predetermined time slot whilst avoiding any time overflow. However, the interactive application may include software means to overcome the time overflows by displaying, for example, a temporization masking image. Other synchronization means predefined in the decoder can be contemplated.

The interactive application is preferably a software package which can be used via most existing interactivity engines, such as Media Highway®, Open TV® or Liberate®.

The television broadcast may be made via a satellite, a cable network, a digital terrestrial network or an Internet type communication network, for example by receiving on a WEB-TV® type television set to the extent that the transmission rate allows this.

The video stream may also include, for each video sequence, at least one sound track. Thus it is possible to block the audio transmission of the sound track which relates to the video sequence, of which the zone of the displayed image is masked by a masking image. The viewer hears the sound track corresponding to the video sequence displayed on his screen.

In addition, validation instructions can subsequently be transmitted to the broadcasting central site. In the case of an interactive game, the validation instructions can enable tokens to be won, which are then stored in the decoder's storage means in the conventional way. It is possible to win any other type of award, or for example participation in a lottery.

According to another aspect of the invention, a device is proposed, to receive a video stream of a television transmission from a broadcasting central site, and to allow display, on a television screen, of a displayed image resulting from the transmission of the video stream. This device includes storage means containing:

a plurality of masking images,

a validation instruction originating from the remote control means,

an interactive application capable of managing the display of these masking images to mask at least one video sequence out of a number of video sequences intended to be displayed on the screen simultaneously, in accordance with the validation instruction and a predetermined time slot.

Moreover the device according to the invention can in addition include means of connection such as a modem for connection to the broadcasting central site and for transmitting the validation instruction.

This device can also include means of reception of time slots transmitted by the central site and means of synchronisation of the masking images to these time slots.

The invention also relates to a digital television system comprising:

a broadcasting central site, broadcasting a video stream to a plurality of television receivers and

a decoder for each television receiver to forward the video stream to the corresponding television receiver.

Each decoder is capable of managing the display of masking images, in order to mask at least one video sequence out of a plurality of video sequences intended to be displayed on the screen simultaneously, in accordance with the validation instruction and a predetermined time slot.

The decoder may be an internal element of the television receiver.

The invention also relates to a method for formatting a video stream intended to be transmitted by a broadcasting central site to a plurality of decoders for an interactive broadcast. According to the invention, the video stream is subdivided into a plurality of time slots. In certain predetermined time slots, the video stream consists of a group of a plurality of video sequences intended to be displayed simultaneously on a screen. Masking images are prepared, which are capable of masking at least one of these video sequences in accordance with the predetermined time slots and in response to a validation instruction.

A specific sound track is associated with each video sequence.

A data stream is also broadcast, into which, from the start of the broadcast, a downloadable interactive application is integrated into each decoder, which application is capable of managing the display of the masking images.

The time slots and the masking images can be transmitted via the data stream.

Also broadcast, at regular time intervals, are synchronisation signals enabling the interactive application to manage the display of the masking images.

Also provided are waiting time slots, during which the interactive application remains in wait for a validation instruction making it possible to determine the masking image to be displayed. In the course of a game, these slots serve to present a question and wait for the viewer to respond by means of his remote control.

With such a system, several viewers can take part during the course of the same broadcast and independently view a video sequence in accordance with their intervention via the remote control.

Other advantages and characteristics of the invention will become apparent on examination of the detailed description of a method of implementation which is by no means limitative, and the attached drawings, in which:

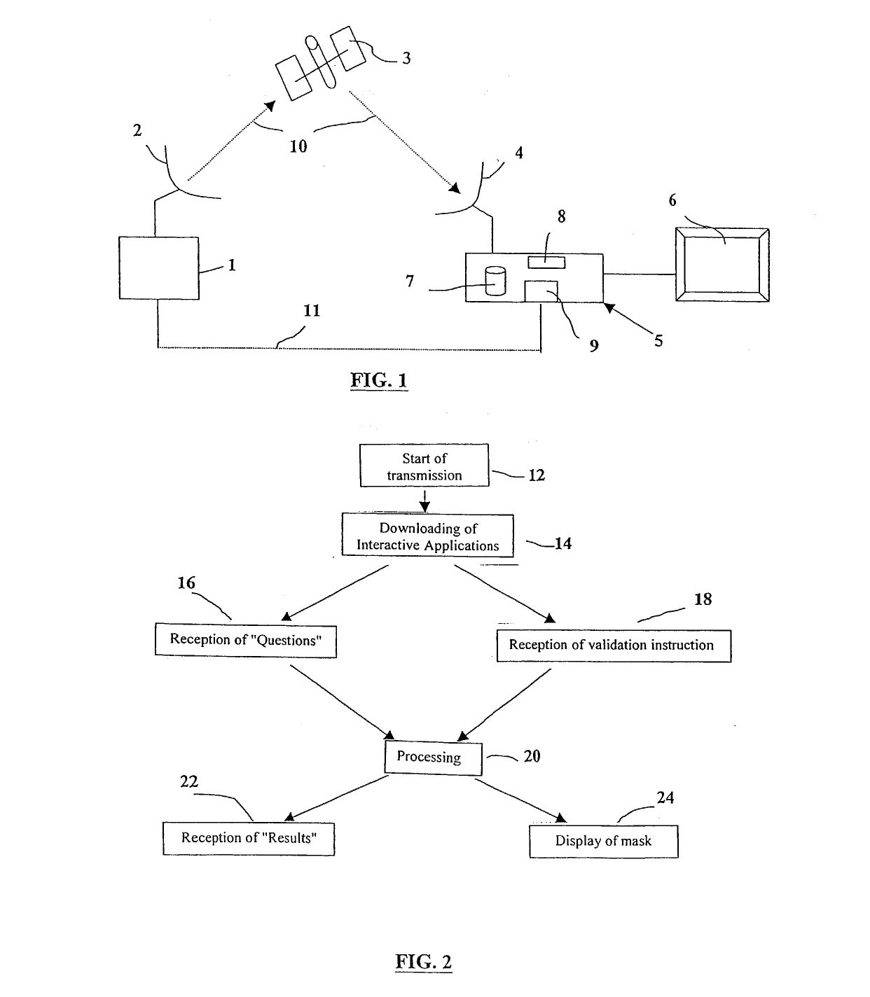

FIG. 1 is a simplified diagram of the material architecture used in the present invention;

FIG. 2 is a flow chart of the main stages of the method according to the invention;

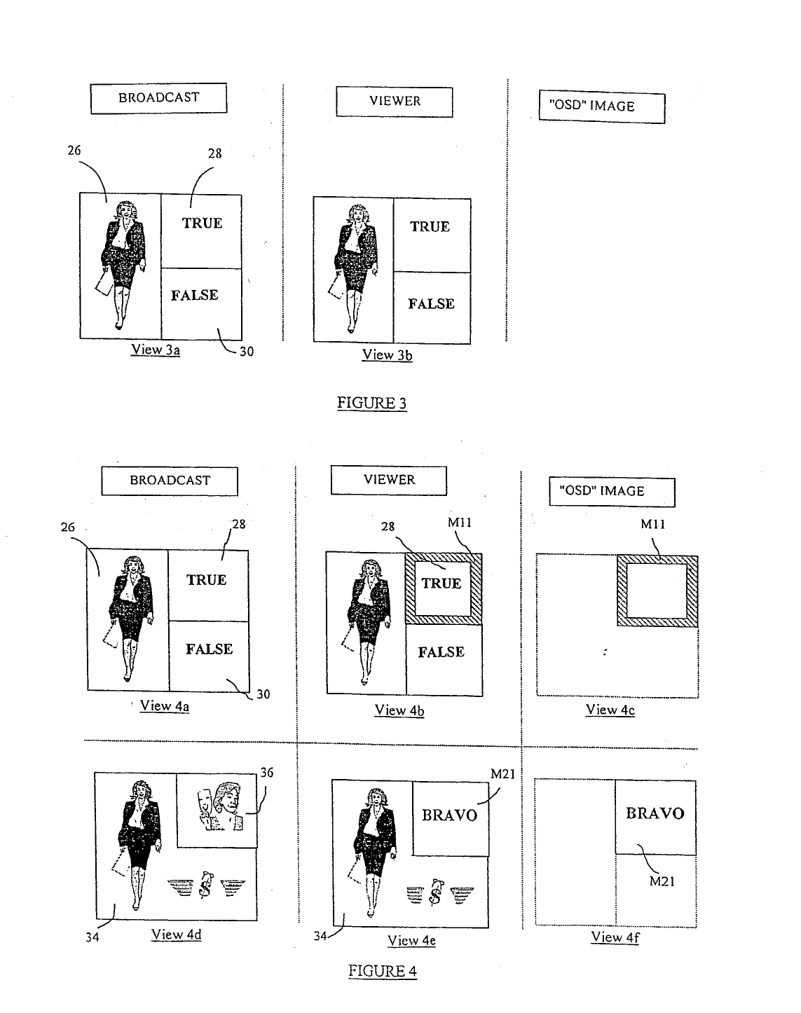

FIG. 3 illustrates different points of view when a presenter poses a question with two responses;

FIG. 4 illustrates the correspondence between the broadcast images, the displayed images and the “OSD” masking images when the viewer gives a “TRUE” response and when the result is displayed;

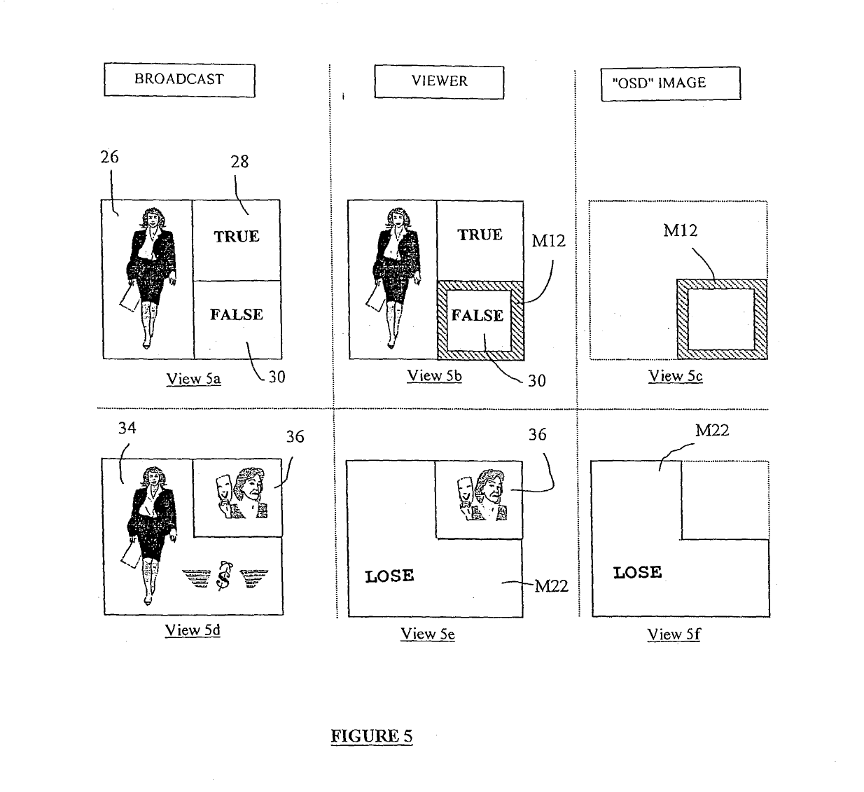

FIG. 5 illustrates the correspondence between the broadcast images, the displayed images and the “OSD” masking images when the viewer gives a “FALSE” response and when the result is displayed;

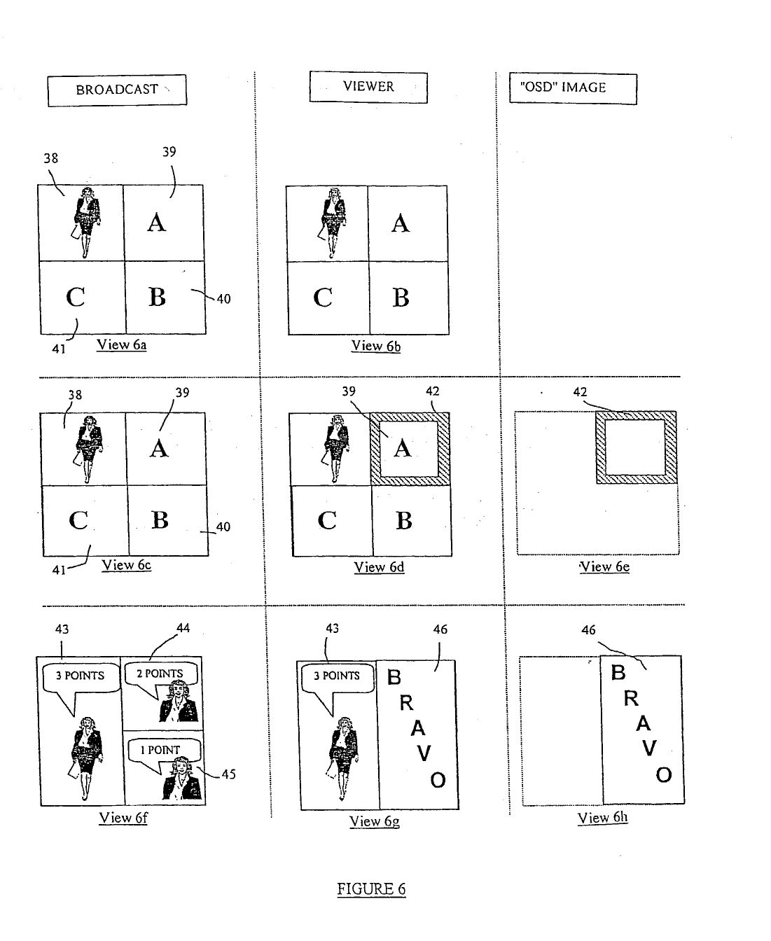

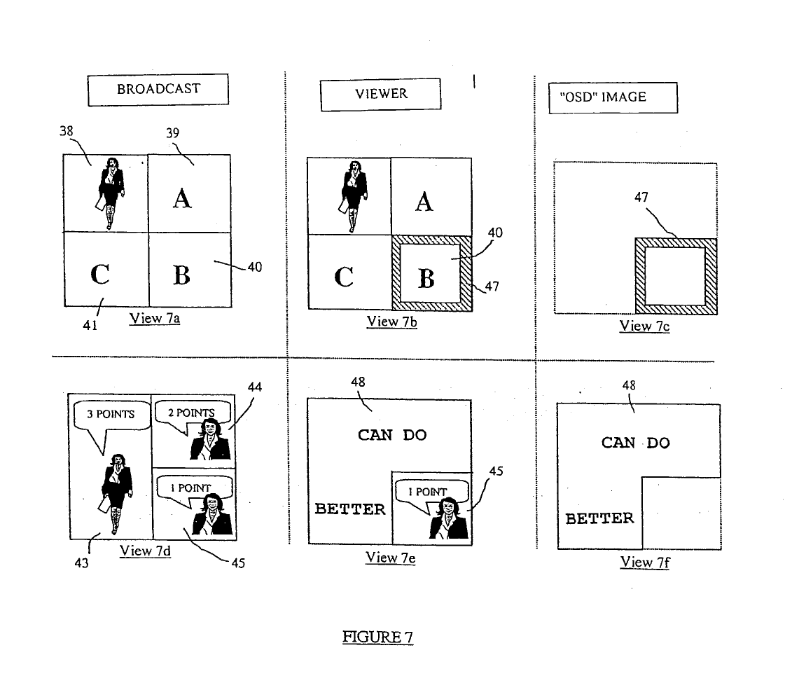

FIG. 6 illustrates the correspondence between the broadcast images, the displayed images and the “OSD” masking images, when the presenter offers a choice of three responses to a question, and when the viewer gives the response “A” and when the result is displayed;

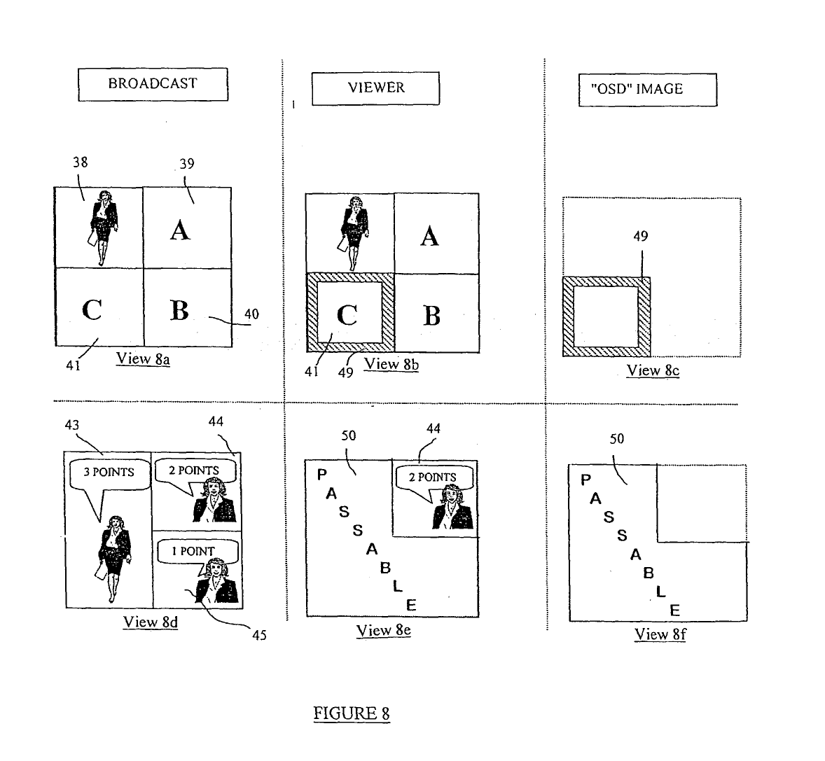

FIG. 7 corresponds to the same question as that in FIG. 6, but in this case, where the viewer gives the response “B”; and

FIG. 8 corresponds to the same question as that in FIG. 6, but in the case where the viewer gives the response “C”.

Although the invention is not limited to this, a description will now be given of an example of the implementation of the method according to the invention for an interactive game, to be more precise, a game in which a male or female presenter poses a question and the viewer must respond with “true” or “false”, by pressing keys “1” or “2” on his remote control.

The present example may be presented within the framework of a game organised by a digital television channel broadcasting films. The viewer requests to view a film. Before showing this film, the channel offers him the chance to take part in the game and win tokens which may enable him to win a second film. This game may be integrated into an entertainment broadcast based on the cinema, for example, or be defined as a programme in its own right.

At each question-response, the viewer either wins or does not win tokens which are counted then saved to be accumulated with tokens that the viewer might win subsequently.

FIG. 1 shows, highly diagrammatically, a broadcasting central site 1, transmitting a broadcast relating to the game and displayed on the viewer's television set 6. The transmission is broadcast in the form of video stream 10 passing via a transmission aerial 2, a satellite 3 and a receiving aerial 4 set up at the viewer's home. The video streams received by the aerial 4 are processed by a decoder 5 before being displayed on the television set 6. The decoder 5 includes conventional elements essential for decryption of the digital video streams, but in particular has a memory 7, a microprocessor 8 and a modem 9 capable of executing the method according to the invention. The memory 7 in particular stores the interactive application managing the method according to the invention and masking images, in particular the low-capacity “OSD” (on-screen display) images. The microprocessor 8 is capable of executing the interactive application and managing a validation instruction from the viewer's remote control. The modem 9 makes it possible to transmit data if necessary to the broadcasting central site 1 via a commuted telephone network 11 or any other communication network.

A description will now be given of the development of the game according to the invention with reference to FIGS. 2 and 3. The flow chart in FIG. 2 illustrates the steps carried out by the decoder, in particular by the interactive application. As illustrated on this flow chart, at the start 12 of the transmission, corresponding for example to the game presentation credits, the decoder 5 downloads the interactive application at step 14, via a data stream transmitted by the broadcasting site.

This application is implemented by the processor 8. At the same time as the interactive application, masking images are downloaded, which are in fact data allowing the generation of predetermined “OSD” images, for example images obtained by control of predetermined pixels. The time slots C1 and C2 are also downloaded relative to preferred points in time: C1 may correspond to the point in time when the question is asked and the viewer makes his choice, and C2 may correspond to the point in time when the result is displayed.

The interactive application includes the necessary information bringing the possible time slots, masking images and validation instructions into relationship with one another. This information can be represented in the following table:

| | TT | |
|---|---|---|
| CC | 1 | 2 |
| C1 | M11 | M12 |
| C2 | M21 | M22 |

Where

TT: remote-control keys

CT: time slots

Mii: masking image

For example, with this table, the interactive application knows that the key “1” makes it possible to display the masking image M11 at the moment of the question C1, and makes it possible to display the masking image M21 at the moment of the result C2, whilst knowing that, as will be seen later on, in C1 the processing is immediate, whilst in C2 the processing is deferred.

At the step 16 corresponding to the time slot C1, the decoder receives a video stream making it possible to simultaneously display three video sequences 26, 28 and 30 according to FIG. 3. The video sequence 26 illustrates an individual asking a question to which the possible responses are “TRUE”, video sequence 28, or “FALSE”, video sequence 30. The image transmitted and the image seen by the viewer are identical, since no masking image is displayed. Still during the course of C1, the decoder starts waiting to receive a validation instruction from the decoder's remote control. When at step 18 the viewer presses, for example, the key “1” on his remote control, the interactive application instantaneously processes this validation instruction and displays the masking image M11. Thus in FIG. 4, views 4a, 4b and 4c, the image transmitted differs from the displayed image which includes a frame M11 superimposed on the image 28. The viewer instantaneously sees the response chosen: “TRUE”. The time slot C1 includes a sufficient period for the viewer to be able to correct his response if he thinks he has made a mistake, and press, for example the key “2” for “FALSE” in accordance with FIG. 5, views 5a, 5b and 5c. In this case the masking image M12 is superimposed on the broadcast image 30.

At the end of the time slot C1, at step 20, the interactive application takes the viewer's last choice into account, for example “TRUE” (key “1”) in view 4b of FIG. 4. The processing consists of determining the masking image that it will be necessary to display in the course of development of the time slot C2 which correspond to video sequences displaying the results. According to the above table, the key “1” for the time slot C2 gives the masking image M21. At step 22, the decoder receives a “Results” video stream, in accordance with view 4d, a video sequence 34 corresponding to a message congratulating the viewer on having found the correct response and simultaneously, in the same video stream, a video sequence 36 indicating to the viewer that he has made the wrong choice. Associated with each video sequence is a sound track. Supposing that “TRUE” is the right response, if the viewer has selected “TRUE” (key “1”), this viewer will see, at step 24, on his screen, the image represented in view 4e, i.e. the video sequence 34, whilst the video sequence 36 is masked by the masking image M21. The two steps 22 and 24 are synchronous and the broadcasting central site can be scheduled to transmit synchronisation signals allowing the interactive application to effectively respect this synchronism between the steps 22 and 24. The viewer thus has the impression that the central site has verified his response and returned him a result in accordance with this response, whilst in reality the processing is carried out locally by the interactive application, using an “OSD” image masking method.

Similarly, if the viewer responds with “FALSE” as displayed in view 5b of FIG. 5, the processing of the interactive application will result in the masking image M22, and the viewer will see the image in view 5e.

FIGS. 6 to 8 illustrate an example in which a presenter, in the video sequence 38 asks a question to which there are three possible responses, these three responses being represented by “A”, “B”, and “C” in three video sequences 39, 40 and 41 in accordance with views 6a and 6b. Thus the video stream comprises four grouped video sequences. Views 6c, 6d, 7a, 7b, 7c, 8a, 8b and 8c correspond to the moment when the viewer is invited to make his choice by means of his remote control.

Views 6c, 6d and 6e in FIG. 6 represent the case where the viewer chooses the response “A” which is predefined as the most favourable response. To symbolise his choice, the response “A” (view 6d) is framed by means of an “OSD” image 42. At the moment of presentation of the results (views 6f, 6g and 6h), the central site transmits in all cases, as will be seen for the responses “B” and “C”, a formatted video stream in which three video sequences 43, 44 and 45 are superimposed. The video sequence 43 corresponds to the most favourable response, i.e. “A”. In this case the interactive application sees to it that the viewer only sees this sequence 43, due to masking of the other two sequences 44 and 45 by means of an “OSD” image 46 in accordance with view 6g.

Views 7a, 7b and 7c in FIG. 7 represent the case where the viewer chooses the response “B” which is predefined as the least favourable response. To symbolise his choice, the response “B” (view 7b) is framed by means of an “OSD” image 47. At the moment of presentation of the results (views 7d, 7e and 7f), the central site thus transmits the video stream illustrated in views 6f (FIG. 6), 7d (FIG. 7) and 8d (FIG. 8). The video sequence 43 corresponds to the least favourable response, i.e. “B”. In this case the interactive application sees to it that the viewer only sees this sequence 45, by masking the other two sequences 44 and 43 by means of an “OSD” image 48 in accordance with view 7e.

Finally, views 8a, 8b and 8c in FIG. 8 represent the case where the viewer chooses the response “C” which is predefined as the average, passable response. To symbolise his choice, the response “C” (view 8b) is framed by means of an “OSD” image 49. At the moment of presentation of the results (views 8d, 8e and 8f), the central site thus transmits the video stream illustrated in views 6f, 7d and 8d. The video sequence 44 corresponds to the average response, i.e. “C”. In this case the interactive application sees to it that the viewer only sees this sequence 44, by masking the other two sequences 45 and 43 by means of an “OSD” image 50 in accordance with view 8e.

Thus a series of several questions-responses can be carried out, and at the end of the series, the interactive application counts the correct responses which are converted into tokens. These tokens, which can be accumulated, are saved in the decoder and the viewer can, for example, obtain a free film.

Of course the invention is not limited to the examples just described, and numerous modifications can be made to these examples without going exceeding the scope of the invention. The method according to the invention can in particular be applied to a report or multi-scenario film or film with various viewing angles. For a multi-scenario film, for example, it may be possible to offer four scenarios to the viewers, who can then select one of the four choices displayed on their screen, the scenario selected by each viewer then being played out on the whole screen. The invention can be applied, in particular, but not limitatively, to the quiz-type programmes divided into a number of areas, such as the cinema, music or sport, but may also be applied to personality tests or in the field of interactive fiction.

1. Method of interactive television, between a broadcasting central site (1) and a plurality of local sites equipped with television receivers (6) provided with decoders (5) to receive digitally encoded video streams (10), characterized in that this method comprises steps of:
transmission, from the broadcasting central site, of a video stream corresponding, in certain predetermined time slots, to a spatial group of several simultaneous video sequences (43, 44, 45), the displayed image resulting from this group comprising at least as many zones as video sequences, and
at each local receiving site, masking steps of one or more of the zones of the displayed image by means of masking images (42, 46, 47, 50), these masking steps being synchronised with predetermined time slots and being carried out within the decoder (5) in response to validation instructions transmitted by means of remote control.

2. Method according to claim 1, characterized in that masking steps are carried out by means of an interactive application included within the decoder's storage means.

3. Method according to claim 2, characterized in that the interactive application is downloaded into the decoder's storage means from the start of broadcasting of the video stream.

4. Method according to claim 2 or 3, characterized in that the predetermined time slots are predefined in the interactive application.

5. Method according to any one of the claims 1 to 3, characterized in that predetermined time slots are defined by synchronization signals transmitted instantaneously by the broadcasting central site.

6. Method according to any one of preceding claims, characterized in that the masking images include fixed low-capacity images.

7. Method according to any one of preceding claims, characterized in that the masking images are downloaded into the decoder's storage means from the start of broadcasting of the video stream.

8. Method according to any one of preceding claims, characterized in that the video stream is broadcast via a satellite.

9. Method according to any one of claims 1 to 7, characterized in that the video stream is broadcast via a cable network.

10. Method according to any one of claims 1 to 7, characterized in that the video stream is broadcast via a digital terrestrial network.

11. Method according to any one of claims 1 to 7, characterized in that the video stream is broadcast via an Internet type communication network.

12. Method according to any one of preceding claims, characterized in that the video stream also include, for each video sequence, at least one sound track.

13. Method according to claim 12, characterized in that the audio transmission of the sound track is blocked, which sound track relates to the video sequence, of which the zone of the displayed image is masked by a masking image.

14. Method according to any one of preceding claims, characterized in that validation instructions are subsequently transmitted to the broadcasting central site.

15. Device to receive a video stream of a television transmission from a broadcasting central site (1), and to allow display, on a television screen (6), of a displayed image resulting from the transmission of the video stream (10), characterized in that this device includes storage means containing:
a plurality of masking images (42, 46, 47, 48, 50),
a validation instruction originating from the remote control means,
an interactive application capable of managing the display of these masking images to mask at least one video sequence out of a number of video sequences (43, 44, 45) intended to be displayed on the screen simultaneously, in accordance with the validation instruction and a predetermined time slot.

16. Device according to claim 15, characterized in that it further comprises connection means for connection to the broadcasting central site and for transmitting the validation instruction.

17. Device according to claim 15 or 16, characterized in that it further comprises means of reception of time slots transmitted by the central site and means of synchronization of the masking images to these time slots.

18. System of digital television for the implementation of a method according to one of any preceding claims, comprising:
a broadcasting central site (1), broadcasting a video stream (10) to a plurality of television receivers (6) and
a decoder (5) for each television receiver to forward the video stream to the corresponding television receiver, characterized in that each decoder is capable of managing the display of masking images (42, 46, 47, 50), in order to mask at least one video sequence out of a plurality of video sequences (43, 44, 45) intended to be displayed on the screen simultaneously, in accordance with the validation instruction and a predetermined time slot.

19. System according to claim 18, characterized in that the decoder is an internal element of the television receiver.

20. Method for formatting a video stream (10) intended to be transmitted by a broadcasting central site (1) to a plurality of decoders (5) for an interactive broadcast, implemented in a system according to claim 18 or 19, characterized in that the video stream is subdivided into a plurality of time slots; in certain predetermined time slots, the video stream consists of a group of a plurality of video sequences (43, 44, 45) intended to be displayed simultaneously on a screen; masking images (42, 46, 47, 50) are prepared, which are capable of masking at least one of these video sequences in accordance with the predetermined time slots and in response to a validation instruction.

21. Method according to claim 20, characterized in that a specific sound track is associated with each video sequence.

22. Method according to one of claims 20 and 21, characterized in that a data stream is also broadcast, into which, from the start of the broadcast, a downloadable interactive application is integrated into each decoder, which application is capable of managing the display of the masking images.

23. Method according to claim 22, characterized in that time slots and masking images are transmitted via the data stream.

24. Method according to one of claims 22 and 23, characterized in that also broadcast, at regular time intervals, are synchronisation signals enabling the interactive application to manage the display of the masking images.

25. Method according to one of claims 22 to 24, characterized in that also provided are waiting time slots, during which the interactive application remains in wait for a validation instruction making it possible to determine the masking image to be displayed.
